(19) United States
(12) Patent Application Publication
(10) Pub. No.: US 2020/0080370 A1
(43) Pub. Date: Mar. 12, 2020

(54) FABRIC PANELS, SHEER FABRICS, AND/OR COVERING FOR ARCHITECTURAL FEATURES, AND RELATED SYSTEMS

(71) Applicant: Hunter Douglas Inc., Pearl River, NY (US)

(72) Inventors: Kelly Quinn Rahn, Dacono, CO (US); Paul G. Swiszcz, Longmont, CO (US); Wendell B. Colson, Vineyard Haven, MA (US)

(21) Appl. No.: 16/562,759

(22) Filed: Sep. 6, 2019

Related U.S. Application Data
(60) Provisional application No. 62/728,352, filed on Sep. 7, 2018.

(51) Int. Cl. E06B 9/40; E06B 9/34; D04C 1/08; D03D 19/00; D04B 21/12

(52) U.S. Cl. CPC E06B 9/40; E06B 9/34; D04C 1/08; D10B 2503/03; D04B 21/12; D10B 2331/04; D10B 2401/061; D03D 19/00

(57) ABSTRACT

A sheer fabric for use in a fabric panel is disclosed where the sheer fabric is formed from a plurality of yarns having a denier from about 25 up to 35, wherein the plurality of yarns are configured and arranged as a plurality of diagonal structures each forming a diamond-shaped opening, wherein the sheer fabric has an openness factor of about seventy five percent (75%) and greater. In one or more embodiments the sheer fabric has properties that resist the formation of puckers, including in an embodiment an improved elongation percentage upon application of a force, and in one or more aspects, an improved variability of the elongation percentage upon application of the force. Additional and alternative properties of the sheer fabric are disclosed. The sheer fabric finds application in a fabric panel or assembly that can be used as a light-controlling covering.

### FIELD OF THE DISCLOSURE

The present disclosure relates to sheer fabrics, flexible fabric panels, and/or coverings and related systems for architectural features, which may include windows, doorways, archways, and the like. More particularly, the present disclosure relates to fabric panels and/or coverings for architectural features having one or more generally vertical support members that provide light transmission and view-through controlling properties.

### BACKGROUND OF THE DISCLOSURE

Current coverings for architectural features include sheer shadings sold under the brand name Silhouette® by Hunter Douglas which typically use generally vertical front and back sheets supporting generally horizontal substantially flexible vane elements, and as described in U.S. Pat. No. 5,313,999, which patent is hereby incorporated by reference herein in its entirety. The vertical support sheets are generally flexible sheer fabrics. The vertical support sheets together with the substantially horizontal flexible vanes form a flexible or soft light-controlling window covering or panel. The flexible nature of the Silhouette® permits it to be operated by rolling and unrolling the flexible light-controlling panel about a roller, and may be referred to as a roll-up type covering. Typically, the sheer panels are made from materials that are clear or dyed white or off-white, and given their strength and durability requirements, result in a muted, somewhat milky view there through (“view-through”). The muted, milky view through is desirable for softening the light being transmitted through the covering, but in direct sun, full view through such sheer materials may be somewhat restricted.

The vanes in Silhouette® are single-layered materials and fabrics, and in certain orientations, these single-layer vanes create shadows on one another. United States published patent application No. 2014/0138037, filed on Mar. 14, 2013 and entitled “Coverings for Architectural Openings with Coordinated Vane Sets”, hereby incorporated herein by reference in its entirety, discloses a flexible roll-up type window covering with dual-layered, generally horizontal vanes supported by generally vertical supporting members or sheets, which in certain positions and orientations may soften or reduce the shadow on the room-facing sheet. United States published patent application No. 2018/0119485, filed on Oct. 28, 2016 and entitled “Covering for architectural features, related systems, and methods of manufacture”, hereby incorporated herein by reference in its entirety, discloses panels and/or coverings for architectural features having generally horizontal flexible vane elements coupled to one or more generally vertical support members, which provide light transmission and view-through controlling properties, which in certain positions and orientations may cause the formation of wrinkles or puckers or creases in one or both of the vertical support members which may be undesirable from an aesthetic standpoint and may also lead to issues during roll-up.

It is desirable to have a light-controlling window panel that provides view-through characteristics and also has a desirable aesthetic look.

### SUMMARY OF THE DISCLOSURE

The present disclosure is directed to a person of ordinary skill in the art. The purpose and advantages of the architectural fabric panel, sheer fabrics, and covering will be set forth in, and be apparent from, the drawings, description, and claims that follow. The summary of the disclosure is given to aid understanding of the panel, sheer fabric, and covering, and not with an intent to limit the disclosure or the invention. It should be understood that each of the various aspects and features of the disclosure may advantageously be used separately in some instances, or in combination with other aspects and features of the disclosure, and/or architectural window coverings in general, in other instances. Accordingly, while the disclosure is presented in terms of embodiments, it should be appreciated that individual aspects of any embodiment can be utilized separately, or in combination with aspects and features of that embodiment or any other embodiment. In accordance with the present disclosure, variations and modifications may be made to the architectural fabric panel, sheer fabric, or covering to achieve different effects.

The present disclosure features in one or more embodiments an improved sheer fabric for use in a fabric panel, the sheer fabric formed from a plurality of yarns wherein the sheer fabric in an embodiment has an openness factor of about sixty-five percent (65%) and greater, including greater than seventy percent (70%), greater than seventy five percent (75%), and about eighty percent (80%) and greater. It will be understood to those skilled in the art that the openness factor percentages are within a normal range of measurement error ranges. The sheer fabric in one or more embodiments has improved elongation percentage upon application of a force with an improved variability of the elongation percentage. The sheer fabric, additionally or alternatively, has an improved maximum break load, and optionally an improved trapezoid tearing load in the machine direction (MD). In an embodiment, the sheer fabric is formed from a plurality of yarns arranged so that the yarns are angularly oriented, e.g., not aligned, with respect to the load, e.g., the primary load, carried by the sheer fabric. Although not limited to any one embodiment, in a particular embodiment the plurality of yarns of the sheer form a plurality of diamond or diagonal structures each having a diamond-shaped opening, for example a Tulle sheer, wherein the load in use is applied to the sheer at the apexes of the diamond structure.

The present disclosure also features in one or more embodiments an improved fabric panel and/or covering for architectural features, which may include windows, doorways, archways and the like, that prevents the formation of wrinkles, puckers, creases, etc. In an embodiment, the covering includes a flexible panel. The flexible panel in an embodiment including a front vertical support member having a height and width; a rear vertical support member having a height and a width, the rear vertical support member substantially parallel to the front vertical support member and laterally moveable relative to the front vertical support member; and a plurality of vanes extending from the front vertical support member to the rear vertical support member, wherein: both the front and rear vertical support members control the movement and angular orientation of the vanes, and at least one of the front or rear vertical support members is a sheer fabric. In an embodiment, the sheer fabric forming the front or rear vertical support member is formed from a plurality of yarns arranged so that the yarns are angularly oriented, e.g., not aligned, with respect to the load, e.g., the primary load, carried by the sheer fabric. Although not limited to any one embodiment, in a particular embodiment the plurality of yarns of the sheer are arranged to form a plurality of diamond structures each having a diamond-shaped opening, for example a Tulle sheer, wherein the load in use is applied to the sheer at the apexes of the diamond structure.

In addition, the present disclosure is set forth in various levels of detail in this application and no limitation as to the scope of the claimed subject matter is intended by either the inclusion or non-inclusion of elements, components, or the like in this summary. In certain instances, details that are not necessary for an understanding of the disclosure or that render other details difficult to perceive may have been omitted. It should be understood that the claimed subject matter is not necessarily limited to the particular embodiments or arrangements illustrated herein.

### BRIEF DESCRIPTION OF THE DRAWINGS

The various aspects, features, and embodiments of the flexible panel, sheer fabric, and architectural covering as disclosed herein will be better understood when read in conjunction with the drawings provided. Embodiments are provided in the drawings for the purposes of illustrating aspects, features and/or various embodiments of the fabric panel, sheer fabric, and architectural covering, but the claims should not be limited to the precise arrangement, structures, subassemblies, features, embodiments, aspects, and devices shown, and the arrangements, structures, subassemblies, features, embodiments, aspects, and devices shown may be used singularly or in combination with other arrangements, structures, subassemblies, features, embodiments, aspects, and devices. The drawings are not necessarily to scale and are not in any way intended to limit the scope of the claims, but are merely presented to illustrate and describe various embodiments, aspects, and features of the architectural covering to one of ordinary skill in the art.

FIG. 1 is a perspective side view of an embodiment of an architectural covering.

FIG. 2 is a perspective view of one embodiment of a covering for an architectural opening in the fully extended position with generally horizontal vanes in an open configuration.

FIG. 3 is a front view of the covering of FIG. 2.

FIG. 4 is a perspective view of the covering of FIG. 2 in the fully extended position with the multi-layered vanes in a closed or collapsed configuration.

FIG. 5 is a perspective view of the covering of FIG. 2 in a retracted position.

FIG. 6 is a side view of an embodiment of the covering where the vanes are in a partially closed position.

FIG. 7 is a side view of the covering of FIG. 6 where the vanes are in a closed position.

FIG. 8 is a side view of a different embodiment of a covering for an architectural opening with multi-layered vanes in an open configuration.

FIG. 9 is a side view of the panel of FIG. 8, as the vanes transition from open to closed.

FIG. 10 and FIG. 11 are exemplary microscopic images of the 20 denier yarn and 30 denier yarn Tulle fabric samples, respectively.

FIG. 12 and FIG. 13 illustrate the results of elongation and deformation test performed on the 30 denier yarn Tulle fabric samples using a 0.03 pound force in the machine direction (MD) and the cross-direction (CD), respectively.

FIG. 14 and FIG. 15 illustrate the results of elongation and deformation test performed on the 30 denier yarn Tulle fabric samples using a 2 pound force in the machine direction (MD) and the cross-direction (CD), respectively.

FIG. 16 and FIG. 17 illustrate the results of a cut strip test performed on the 30 denier yarn Tulle fabric samples to determine the maximum break load in the machine direction (MD) and the cross-direction (CD), respectively.

FIG. 18 and FIG. 19 illustrate the results of a trapezoid tear test performed on the 30 denier yarn Tulle fabric samples to determine the average tearing load in the machine direction (MD) and the cross-direction (CD), respectively.

### DETAILED DESCRIPTION OF THE DISCLOSURE

In the following detailed description, numerous details are set forth in order to provide an understanding of a flexible panel, sheer fabric, and an architectural covering, its method of operation, and method of manufacture. However, it will be understood by those skilled in the art that the different and numerous embodiments of the flexible fabric panel, sheer fabric and/or architectural covering, and its method of operation and manufacture may be practiced without these specific details, and the claims and invention should not be limited to the embodiments, subassemblies, or the specified features or details specifically described and shown herein. The description provided herein is directed to one of ordinary skill in the art and in circumstances, well-known methods, procedures, manufacturing techniques, components, and assemblies have not been described in detail so as not to obscure other aspects, or features, of the fabric panel, sheer fabric, and/or architectural covering.

Accordingly, it will be readily understood that the components, aspects, features, elements, and subassemblies of the embodiments, as generally described and illustrated in the figures herein, can be arranged and designed in a variety of different configurations in addition to the described embodiments. It is to be understood that the covering may be used with many additions, substitutions, or modifications of form, structure, arrangement, proportions, materials, and components which may be particularly adapted to specific environments and operative requirements without departing from the spirit and scope of the invention. The following descriptions are intended only by way of example, and simply illustrate certain selected embodiments of an architectural covering. For example, while the architectural covering is shown and described in examples with particular reference to its use as a window covering to control light and view-through, it should be understood that the covering will have other applications as well. In addition, while the detailed description in many examples is generally directed to a covering formed of one or more generally vertical supporting members described as sheets and particularly sheer sheets, it will be appreciated that the disclosure and teachings have application to other materials forming the vertical support members, such as, for example, tapes, strips, sheets, panels, and combinations thereof. Furthermore, while some embodiments and examples disclose light controlling elements, referred to herein as vanes or slats, including the use of multi-layered vanes which preferably form multi-layered cellular vanes, it will be appreciated that the disclosure and teachings have application to coverings having cellular vanes and/or single layered vanes, as well as cellular or non-cellular covering that do not contain light-controlling “vanes” or “slats”. The claims appended hereto will set forth the claimed invention and should be broadly construed to cover architectural coverings, flexible, preferably fabric, panels, and in instances sheer fabrics, unless otherwise clearly indicated to be more narrowly construed to exclude embodiments, elements, and/or features of the covering, panel, and/or fabric.

Throughout the present application, reference numbers are used to indicate a generic element or feature of the covering. The same reference number may be used to indicate elements or features that are not identical in form, shape, structure, etc., yet which provide similar functions or benefits. Additional reference characters (such as letters, primes, or superscripts, as opposed to numbers) may be used to differentiate similar elements or features from one another. It should be understood that for ease of description the disclosure does not always refer to or list all the components of the covering, and that a singular reference to an element, member, or structure, e.g., a singular reference to a generally vertical support member, a horizontal vane element, or a strip or a vane, may be a reference to one or more such elements, unless the context indicates otherwise.

In the following description of various embodiments of the architectural covering, it will be appreciated that all directional references (e.g., proximal, distal, upper, lower, upward, downward, left, right, lateral, longitudinal, front, rear, back, top, bottom, above, below, vertical, horizontal, radial, axial, interior, exterior, clockwise, and counter clockwise) are only used for identification purposes to aid the reader's understanding of the present disclosure unless indicated otherwise in the claims, and do not create limitations, particularly as to the position, orientation, or use in this disclosure. Features described with respect to one embodiment typically may be applied to another embodiment, whether or not explicitly indicated.

Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. Identification references (e.g., primary, secondary, first, second, third, fourth, etc.) are not intended to connote importance or priority, but are used to distinguish one feature from another. The drawings are for purposes of illustration only and the dimensions, positions, order and relative sizes reflected in the drawings may vary.

As used herein, with respect to nonwoven fabrics, the term “machine-direction” or “MD” refers to the direction in which continuous strands or filaments are laid down on a support as the nonwoven fabric is produced, for example on commercial nonwoven fabric making equipment. Likewise, the term “cross-direction” or “CD” refers to the direction perpendicular to the machine-direction. With respect to fabrics, the terms refer to the corresponding directions of the fabric with respect to the filaments used to produce the fabric. These directions are distinguished herein because the mechanical properties of nonwoven fabrics can differ, depending on how the test sample is oriented during testing. For example, tensile properties of a nonwoven fabric differ between the machine-direction and the cross-direction, due to the orientation of the constituent fibers, and other process-related factors.

### General Operation of Preferred Embodiment of the Covering

The present disclosure relates to coverings for architectural features which include, for example, windows, door frames, archways, and the like. The coverings are particularly useful for windows to provide an aesthetic look, and desirable shading and privacy. The coverings in an embodiment generally comprise a flexible subassembly or panel that includes one or more flexible, moveable, generally horizontal vane elements extending between one or more flexible, movable, generally vertical front and/or rear support members. The generally horizontal vane elements, also referred to as vanes or slats herein, preferably are formed of fabric and have a different light transmissivity or translucence than the generally vertical support members, and the vanes and support members together control view-through and light transmission through the covering. Other types and styles of covering are contemplated, such as, for example, cellular accordion style shades that open and close by stacking, and the teachings and disclosure are not limited to roll-up style coverings.

The one or more generally vertical support members in an embodiment are formed of fabric and in an embodiment are substantially parallel to each other and in embodiments may not have any fold lines, creases and the like. The generally vertical support members may include, for example, sheets, panels, tapes, strips, or the like, and combinations of these elements. Each vertical support member may be formed of a single or multiple piece(s) of material, and may be substantially flat and planar. The vertical support members have a height (length), width and thickness, their thickness (generally perpendicular to their height and width) may be relatively thin, and the vertical support members generally are made of materials that are much thinner than their respective length (height) and/or width. The “height” of the vertical support members, also referred to as the “length”, generally and typically corresponds to and is associated with the height or vertical dimension of the covering or panel, while the width of the vertical support members generally and typically corresponds to the width of the covering or panel, and the width of the architectural opening. The width of the vertical support members may or may not extend the length of the vane elements. In one embodiment the height and width of the front and/or rear vertical support member is substantially the same as the height and width of the panel. For ease of reference and without intent to limit the disclosure, the one or more vertical support members sometimes will be referred to in the disclosure as sheets, and in one or more embodiments, the one or more front and rear vertical support members are formed of sheers.

The front and rear generally vertical support members, and the vane elements, may be substantially any type of material, and are preferably formed from flexible materials, such as, but not limited to, textiles, fabrics, and films, including knits, wovens, non-wovens, and so on. For ease of reference, the subassembly including the support members will be referred to as a light-controlling panel, subassembly, or “panel” for short. In one exemplary embodiment, the generally one or more vertical support members are made from generally flexible, soft materials, and form a generally flexible subassembly or panel for the covering.

Additionally, the vertical support members preferably have light transmissivity properties varying from translucent to substantially transparent or clear. In one embodiment, at least one, preferably both, of the front and/or rear supporting members are sheers and/or materials that permit light to pass there-through.

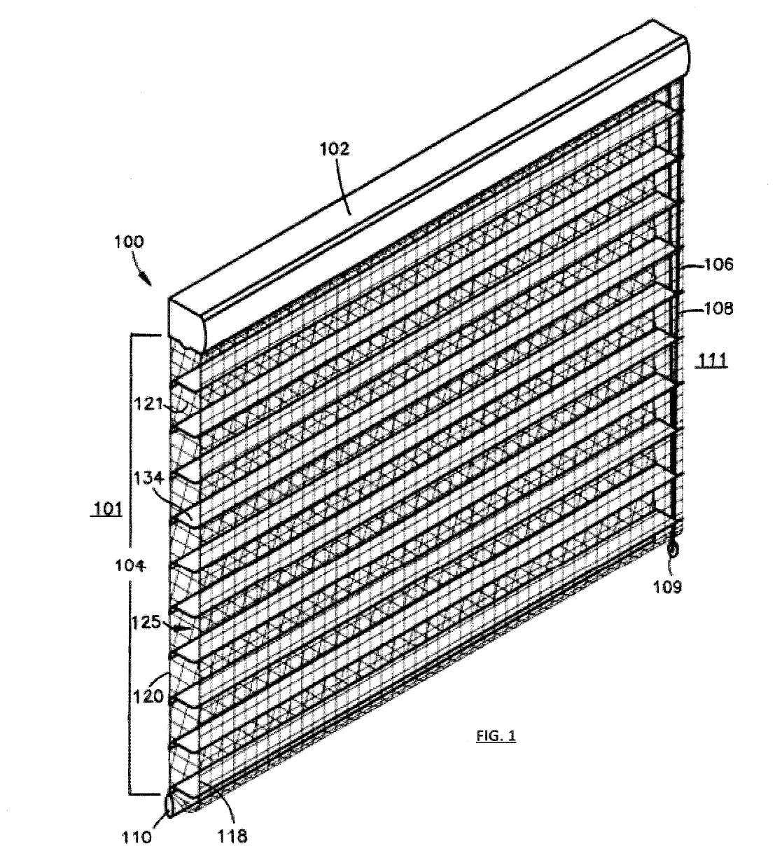

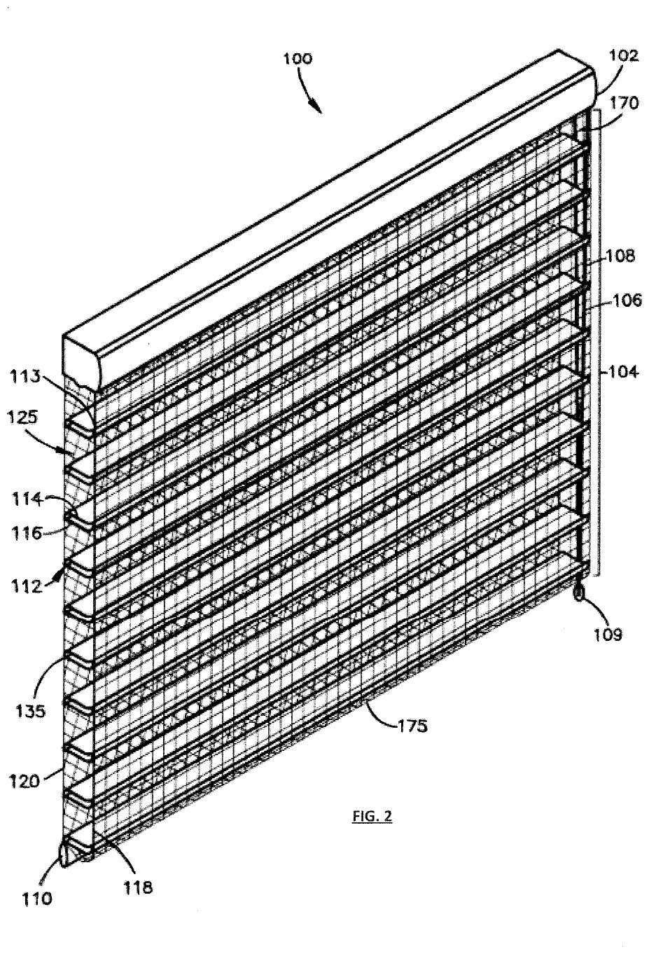

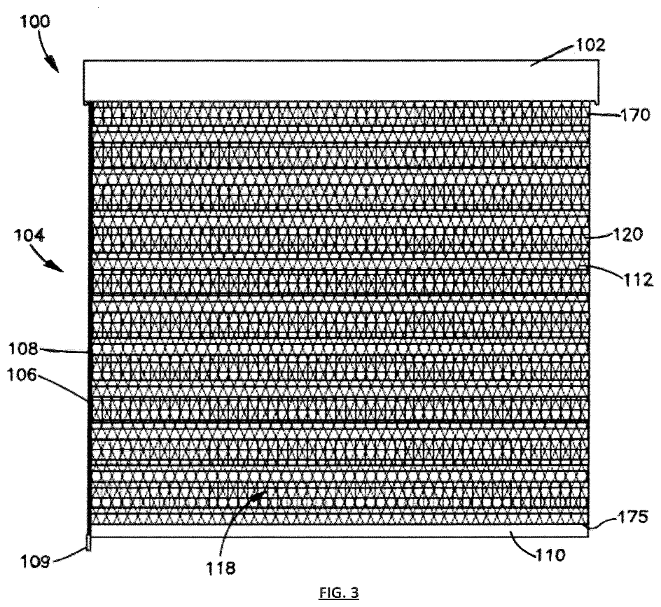

Referring generally to the illustrative embodiments of FIGS. 1-9, the covering 100 in one embodiment generally includes a headrail 102, a roller 126 associated with the head rail, a light-controlling panel 104, a bottom rail or weight 110, and a control mechanism 106 to operate the covering (e.g., a mechanism to rotate the roller) and control the amount, quality, and manner in which light is blocked or transmitted through the panel, as well as the aesthetic look and appearance of the panel. In one embodiment, a head tube or roller 126 supports and is connected to a top end 170 of panel 104, and bottom rail 110 is connected to a bottom end 175 of panel 104. In an embodiment, the panel may have one of a front and/or rear vertical support member, and preferably has front and rear vertical support members. In one embodiment, the front and rear vertical support members are coupled directly or indirectly to the roller, and preferably at different horizontally extending locations along the circumference of the roller to provide lateral movement of the front and rear vertical support members relative to each other. Head rail 102 may support the roller 126 and the panel may be connected to roller 126 over an architectural opening, and thus head rail 102 may generally correspond to the shape and dimensions (e.g., width) of the top of the architectural opening. Panel 104 includes generally horizontal vanes 112 extending between a generally vertical front support member 118 and a generally vertical rear support member 120. Vanes 112 extend from and between, and may be coupled to, front and rear support members 118, 120, and move between a first or open position where at least a middle portion of the vanes are substantially horizontal and generally orthogonal to the front and rear support members and a second or closed position where at least a middle portion of the vanes are substantially vertical and generally parallel to the front and rear support members. In an embodiment, the generally vertical support members 118, 120 are substantially parallel to each other whether the vane elements are in an open or closed position, and the generally vertical support members have no fold lines, creases, or the like.

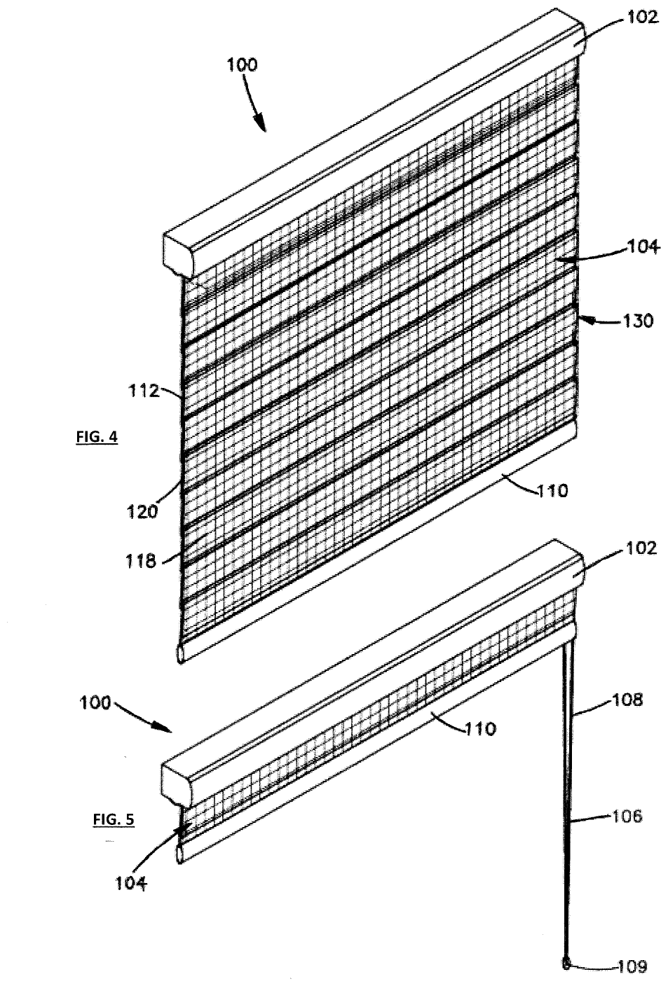

Covering 100 may include a control mechanism 106 for controlling the retraction and extension of light-controlling panel 104 to control the height of the covering in the opening and hence the nature and quality of the light transmitted through, the view-through characteristics, and the shape and aesthetic nature of panel 104. The control mechanism 106 may also control the angular orientation of horizontal vane elements 112 with respect to support members 118, 120 which will also affect the nature and quality of the light transmitted through, the view-through characteristics, and the shape and aesthetic appeal of the panel 104. In the rollup-type window covering illustrated in FIGS. 1-9, the control mechanism 106 preferably rotates roller 126. In particular, control mechanism 106 rotates roller 126 in order to retract or extend the light controlling panel 104, or angularly orient vanes 112 of light-controlling panel 104. The light-controlling panel may move between a fully retracted position where the panel is completely wrapped about the roller, to a fully extended position where the panel is completely unwound from the roller and extends in the opening with the vertical support members generally parallel and adjacent to each other with the vanes located between the support members and oriented substantially vertical and parallel to the vertical support members (see FIG. 4). In one example, control mechanism 106 may include a cord 108 for rotating the roller, and/or may include a pulley 109, a direct drive arrangement, a gear train, and/or a clutch mechanism. The system or mechanism for controlling the rotation of roller 126 may include an electric motor which may be controlled manually by a user, or through a pre-programmed or programmable software control unit, such as a remote control. Control mechanism may include any desired control mechanism including those now known and control mechanisms developed in the future. In addition, while control mechanisms discussed above are directed primarily to rotating a roller or mechanisms for a roll-up type covering, it will be appreciated that other arrangements and mechanisms now known or later developed, for example, mechanisms for stacking and folding arrangements, and/or lifting of the bottom rail may instead be used to control movement of the panel 104.

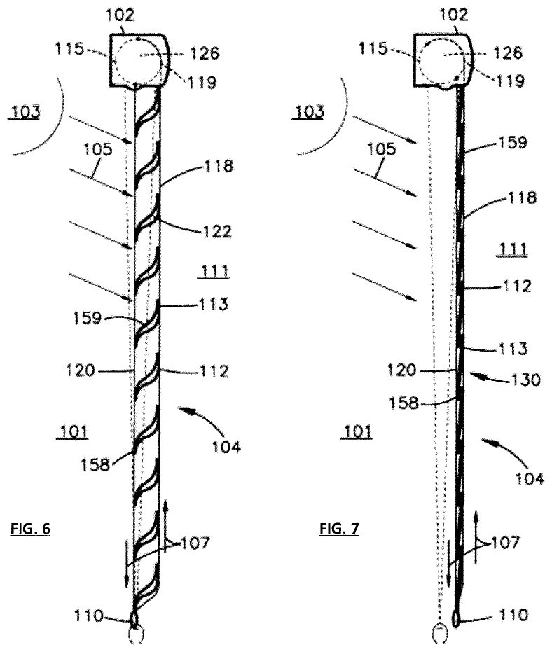

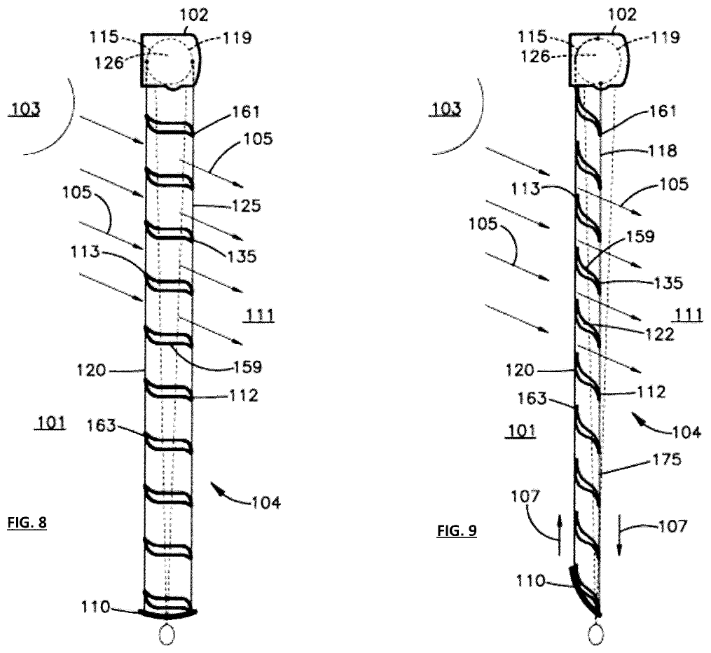

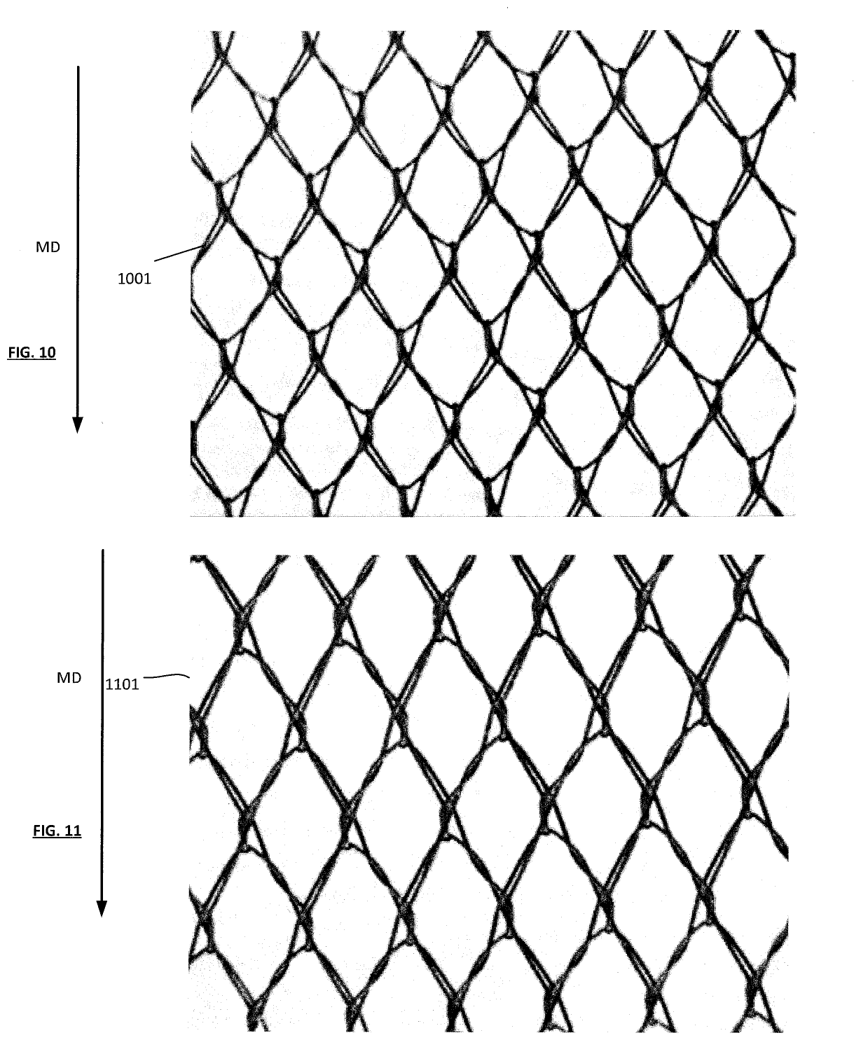

For ease of reference purposes, when used, for example, as a window covering, the generally vertical support member 120 that faces the exterior 101 of the window opening is referred to as the rear support member or sheet, while the generally vertical support member 118 that faces the interior 111 of the window opening is referred to as front support member or sheet 118. The angular orientation and movement of vanes 112, in a roll-up type covering having vanes 112 extending between and coupled to vertical support members, is effected by relative movement of the support members. Front and rear support members 118, 120 may move vertically in unison as they are unrolled from roller 126 (FIG. 4) to extend in the window opening. After the window covering is fully extended and unrolled from roller 126 (shown in FIG. 5), further rotation of roller 126 moves front support member 118 and/or rear support member 120 laterally or horizontally away from each other, and further moves front and rear support members 118, 120 in relative vertically opposite directions (FIGS. 6 and 7, & 8 and 9). The vanes of the window covering may extend between the vertical support members in different manners so as to orient the vanes in different angular orientations or directions and configure them to operate or move in different directions and orientations to effect the amount of light transmitted through the panel and/or the visibility through the covering. A shading orientation is shown in FIGS. 6 and 7 and a privacy orientation is shown in FIGS. 8 and 9. In the privacy orientation, a person under the window and looking up may be blocked from viewing into the room due to vanes 112 blocking their view-through. One skilled in the art can also appreciate that generally the light-controlling and view-through characteristics including the angular orientation and relative movement of vanes 112 in a roll-up type covering, may be affected by whether the support members extend from the rear side 115 or front side 119 of the roller and/or the direction of rotation of the roller.

The material and design for the front and rear support members 118, 120 are independent aspects of the design of panel 104. In one embodiment, the front and rear support members may be formed partially or wholly as sheers, and more preferably sheer fabrics. A sheer is a material that has openings that permit light and view-through. The openness of a material, e.g., a sheer, may be measured by its openness factor which measures the percent of open space in, for instance, a material, where a 60% openness factor (“OF”) has 40% material and 60% holes or open spaces. The higher the openness factor OF, the more sheer and better view through provided by the material. One manner of measuring openness factor is to measure the area of the yarns and/or open areas and calculate the percentage of area that has no material. In one example, a digital microscope or high resolution camera may be used to capture an image of the material and the image used to calculate the percentage that does not have fabric, yarns, or material. A Motic digital microscope and Motic Image Plus 2.0 Software may be used to measure the openness factor of various materials.

Support members with a higher openness factor of as small as sixty percent (60%) to as high as eight six percent (86%) in increments therebetween of about one percent (1%) are preferred for aesthetic reasons. It will be understood to those skilled in the art that the percentage ranges disclosed in this specification are within a normal margin of measurement errors.

In certain embodiments, the openness factor is about sixty five percent (65%) to about eighty percent (80%), about seventy percent (70%) to about seventy five percent (75%), about eighty percent (80%) to about eighty five percent (85%), or the like. In particular, support members with a high openness factor, preferably greater than sixty percent (60%), more preferably greater than sixty-five percent (65%), greater than seventy percent (70%), more preferably greater than seventy-five percent (75%), and/or greater than eighty percent (80%) or higher, in increments therebetween of about one percent (1%), may be preferred for aesthetic reasons. In embodiments, different finer (thinner) yarns may be used which may contribute to a higher openness factor. Use of dark colored or black yarns may be advantageous for the additional reason that sunlight may not degrade the materials in the covering, and the materials will retain their strength.

When constructing a panel 104 having two support members formed as sheers, partial sheers, or with numerous openings as the vertical supporting members, factors such as strength, durability, stretch (elongation), UV degradation, and moiré light interference are all factors in the design of an acceptable covering 100. Moiré may occur as a result of light interference when two sheer materials overlay each other and light is transmitted therethrough. Moiré which is a light interference artifact that may occur in a covering having front and back sheers as vertical support members, is preferably avoided or at least minimized and reduced when producing a covering, particularly coverings for windows and the like where light passes there through.

One manner of reducing moiré is to use different sheer fabrics for the front support member and the rear support member, and/or selecting, processing, and/or configuring sheer fabrics so that the yarns, and interstitial spacing and connection points do not align or nearly align.

In one embodiment of panel 104, an orthogonal grid fabric may be used as front support member 118. For example, a Leno or gauze weave sheer fabric may be used for the front support member 118. In a Leno sheer fabric, warp yarns are used in pairs and twisted together to trap the weft yarns in place so that the yarns do not slide, which would alter their spacing. The Leno sheer fabric allows a wider spacing of yarns and a very open weave with fine yarn which provides good view-through. In one embodiment, the Leno weave for the front support member has a cross-direction density of about 21 yarns per inch (ypi) (cross yarn is two yarns twisted together) and a machine direction density of about 25 ypi. Other cross and machine direction density values are contemplated and exemplary values would range from about 15 to about 30 cross direction ypi and about 15 to about 30 machine direction ypi depending upon the yarn denier. In another embodiment, the fabric for the front support member is a Leno or plain weave, with 22 warp ypi and 22 pairs of weft ypi.

Preferably, the front support member has an openness factor of as small as about sixty percent (60%) to about as high as about eighty five percent (85%), which may vary therebetween in increments of about one percent (1%). In certain embodiments, the openness factor is about sixty five percent (65%) to about eighty percent (80%), about seventy percent (70%) to about seventy five percent (75%), about eighty percent (80%) to about eighty five percent (85%), or the like. Preferably, the front support member is a sheer fabric that has an openness factor of greater than sixty percent (60%), more preferably greater than about sixty-five percent (65%), more preferably about seventy percent (70%) or higher including about seventy-five percent (75%), about eighty percent (80%), and about eighty-five (85%). In one embodiment, the Leno weave for the front support member has rectangularly-shaped openings with dimensions of about 7.3 mm in width (distance between paired warp yarns) and about 4.1 mm in length (distance between weft yarns).

The Leno sheer fabric, in an embodiment, may be made from monofilament or multifilament yarn with a warp denier that ranges from about 16 to about 24, about 18 to about 22, and preferably about 20 denier. The denier of the weft yarn, in an embodiment, may be as small as about 45 denier to as high as about 55 denier, and preferably about 50 denier. An example of a Leno sheer fabric for use in the covering is an Englebert Steiger Leno fabric which has 20 denier warp yarns and 50 denier filling or weft yarns. The Englebert Steiger Leno sheer fabric preferably has an openness factor greater than about sixty-five percent (65%). While, the Leno sheer fabric with orthogonal grid has been discussed as being used as the front vertical support member, it will be appreciated that the Leno sheer fabric may be used as the rear vertical support member and other materials, including preferably sheer materials, may be used as the front vertical support member.

Further, a different fabric with high openness factor (e.g., greater than 60%, greater than 75%, and in one or more embodiments, greater than 80% or higher) is used for the rear support member 120. One example of a different fabric for use as the rear support member 120 is a sheer fabric where the filaments or yarns forming the fabric are angularly oriented and are not aligned with the load, e.g., the primary load, applied to the fabric. One embodiment of a different sheer fabric for use as a vertical support member is a diagonal or diamond grid fabric formed from a plurality of yarns arranged to form a plurality of diamond structures each forming a diamond-shaped opening where the load in use is not aligned with the plurality of yarns. That is the plurality of yarns forming the sheer fabric form a diagonal grid structure having diamond-shaped openings in between the plurality of yarns where the load in use is applied at an angle with respect to the direction of the yarns, e.g., the load is applied at the upper and bottom points or apexes of the diamond structure in a manner that would lengthen or stretch the diamond structure. The diamond grid structure having diamond-shaped openings in an embodiment is formed by knitting, and in a particular embodiment is a knit Tulle sheer fabric. Other fabrics with similar properties, openness factor, and/or structures, e.g., yarns that are angularly oriented, e.g., not aligned, with respect to the applied load, are within the scope of this disclosure.

The rear support member in an embodiment is a sheer formed from a plurality of yarns that are arranged to form a plurality of diamond or diagonal grid structures with each diamond or diagonal structure having a diamond-shaped opening where the sheer fabric preferably has an openness factor as low as about sixty percent (60%) and as high as about eighty five percent (85%), which may vary therebetween in increments of about one percent (1%). In one embodiment the rear support member preferably has an openness factor greater than about sixty percent (60%), more preferably greater than sixty-five percent (65%), more preferably greater than seventy percent (70%) or higher including greater than seventy-five percent (75%), about eighty percent (80%) or higher, and about eighty-five percent (85%). In one embodiment, the rear support member is a Tulle sheer fabric having an openness factor of greater than seventy-five percent (75%) and less than ninety percent (90%), and more preferably between about eighty percent (80%) and about eighty-six percent (86%). While this disclosure describes an openness factor of as low as about sixty percent (60%) and as high as about eighty-five percent (85%), in increments therebetween of about one percent (1%), other openness factors are within the scope of this disclosure and may be selected based on various design considerations for the panel 104 (for example, blocking light and/or desired view through characteristics).

While a sheer fabric having a plurality of yarns configured and arranged to form a plurality of diamond or diagonal grid structures with diamond-shaped openings, and particularly a knit Tulle sheer fabric, has been disclosed as being used for the rear vertical support member, it may be appreciated that a diamond grid sheer fabric having diamond-shaped openings, for example a knit Tulle sheer fabric, may be used for the front vertical support member and other materials, including preferably sheer materials, may be used for the rear vertical support member. The sheer fabric for use as one of the vertical support members is not limited to a Tulle sheer fabric, and/or a diagonal grid structure with diamond-shaped openings, as other sheer fabrics are contemplated.

Front and rear support members with an openness factor that ranges from as low as about sixty percent (60%) to as high as about eighty-six percent (86%) have produced desirable results. In an embodiment, the rear support member 120 has an openness factor that is greater than the openness factor of the front support member 118. The sheer fabric having diamond-shaped openings, preferably Tulle sheer fabric, having desired openness factor of greater than 65%, greater than 75% and greater than 80% and higher may be made on an about 25 to about 30 gauge warp knitting machine, and preferably a twenty-eight (28) gauge warp knitting machine. In a twenty-eight (28) gauge warp knitting machine, twenty-eight (28) warp yarns per inch are fed into the knitter, and no fill yarns are used on the warp knitter. In an exemplary embodiment, the Tulle fabric for the rear support member is about 25-30 gauge (yarns), preferably 28 gauge (yarns), in the cross (width) direction and about 10 courses per inch in the machine direction.

Sheer fabrics having a plurality of yarns arranged in a diamond or diagonal grid structure with each structure having a diamond shaped opening, including knitted sheer fabrics and particularly for example knitted Tulle sheer fabric, while advantageous for reducing moiré and providing improved view through, can elongate and stretch over time as the load is applied vertically at the bottom and top apexes or points of the diamond structure, which may facilitate or cause the formation of wrinkles or creases, sometimes referred to as “puckers”. The effect may not be aesthetically pleasant and may cause issues during roll-up of the light-controlling panel. This disclosure describes in an embodiment the use of a sheer fabric formed from a plurality of yarns forming a diamond grid structure, and in a particular embodiment a knitted Tulle sheer fabric, that is formed of yarn having a denier of about 25 or greater, including a denier as low as about 25 to as high as about 35 denier yarn, preferably a 30 denier yarn, that may be monofilament or multifilament. In an embodiment, sheer fabric with the yarns forming diamond-shaped structures, e.g., a knitted Tulle fabric, is formed of denier yarn of greater than 25, such as, for example, 30 denier yarn, selected such that the openness factor is at least 65% and as high as about eighty-six percent (86%), or higher.

In an embodiment, the front and/or rear support member may be a sheer fabric formed of yarns arranged in a diamond or diagonal grid structure defining a plurality of diamond-shaped openings (e.g., a Tulle knit fabric) that has an openness factor as low as about sixty percent (60%) and as high as about eighty-five percent (85%), in increments therebetween of about one percent (1%), and has an elongation percentage on average less than about 0.70% in the machine direction (MD) upon application of a 0.03 pound force. Preferably, the diamond grid fabric (e.g., Tulle fabric) has an elongation percentage on average of not more than 0.65% elongation, not more than 0.60% elongation, not more than 0.55% elongation, or not more than 0.50% elongation in the machine direction (MD) upon application of a 0.03 pound force. Preferably, the openness factor may be greater than about sixty percent (60%), more preferably greater than sixty-five percent (65%), more preferably greater than seventy percent (70%) or higher including greater than seventy-five percent (75%), about eighty percent (80%) or higher, and about eighty-five percent (85%). The variability of elongation of such a diamond grid fabric, in an embodiment, is on average less than about 0.100% upon application of a 0.03 pound force in the machine direction (MD).

In another embodiment, the front and/or rear support member can be a sheer with the yarns arranged in a diamond or diagonal grid structure having diamond-shaped openings (e.g., a Tulle knit fabric) that has an openness factor as low as about sixty percent (60%) and as high as about eighty-five percent (85%), in increments therebetween of about one percent (1%), and has an elongation percentage on average less than about 5.0%, preferably less than about 3.0%, in the machine direction (MD) upon application of a 2.0 pound force in the machine direction (MD). Preferably, the diamond grid fabric (e.g., Tulle fabric) has an elongation percentage on average of not more than 4.5%, not more than 4.0%, not more than 3.5%, and not more than about 3.0% in the machine direction (MD) upon application of a 2.0 pound force in the machine direction (MD). Preferably, the openness factor may be greater than about sixty percent (60%), more preferably greater than sixty-five percent (65%), more preferably greater than seventy percent (70%) or higher including greater than seventy-five percent (75%), about eighty percent (80%) or higher, and about eighty-five percent (85%). The variability of elongation of such a fabric in the machine direction (MD), in an embodiment, is on average less than about 0.38% upon application of a 2.0 pound force in the machine direction (MD).

In an embodiment, the front and/or rear support member can be a sheer fabric with the yarns arranged in a diamond grid structure having diamond-shaped openings (e.g., a Tulle knit fabric) that has an openness factor as low as about sixty percent (60%) and as high as about eighty-five percent (85%), and has a maximum break load of on average greater than about 10 pound force in the machine direction (MD). Preferably, the diamond grid fabric (e.g., Tulle fabric) has a maximum break load of on average greater than about 12 pound force, greater than about 14 pound force, or greater than about 16 pound force. Preferably, the openness factor may be greater than about sixty percent (60%), more preferably greater than sixty-five percent (65%), more preferably greater than seventy percent (70%) or higher including greater than seventy-five percent (75%), about eighty percent (80%) or higher, and about eighty-five percent (85%), in increments therebetween of about one percent (1%).

In an embodiment, the front and/or rear support member can be a sheer fabric with the yarns arranged in a diamond or diagonal grid structure having diamond-shaped openings (e.g., a Tulle knit fabric) that has an openness factor as low as about sixty percent (60%) and as high as about eighty-five percent (85%), and has a trapezoid tearing load of on average greater than about 5.50 pound force in the machine direction (MD). Preferably, the diamond grid sheer fabric (e.g., Tulle fabric) has a trapezoid tearing load of on average greater than about 6 pound force, greater than about 6.5 pound force, or greater than about 7 pound force. Preferably, the openness factor may be greater than about sixty percent (60%), more preferably greater than sixty-five percent (65%), more preferably greater than seventy percent (70%) or higher including greater than seventy-five percent (75%), about eighty percent (80%) or higher, and about eighty-five percent (85%), in increments therebetween of about one percent (1%).

United States published patent application No. 2014/0138037, filed on Mar. 14, 2013 and entitled “Coverings for Architectural Openings with Coordinated Vane Sets”, hereby incorporated herein by reference in its entirety, described a Tulle fabric for forming the rear support member 120 of a light-controlling panel that is formed of 20 denier yarn. However, the use of the 20 denier yarn knit Tulle fabric may result in elongation over time, which may facilitate or cause the formation of wrinkles or creases, sometimes referred to as “puckers”. The effect may not be aesthetically pleasant and may cause issues during roll-up of the light-controlling panel. This disclosure in one or more embodiments describes the use of a sheer fabric having yarns arranged in a diamond grid structure with diamond shaped openings, for example, a Tulle fabric, that in one or more aspects is formed of yarn having a denier of about 25 or greater, including a denier as low as about 25 to as high as about 35 denier yarn, e.g., a 30 denier yarn, that may be monofilament or multifilament. In an embodiment, the sheer fabric formed of a plurality of yarns arranged in diamond-shaped structures, e.g., a Tulle fabric, is formed of denier yarn of greater than 25, such as, for example, 30 denier yarn, selected such that the openness factor is at least 65%, and in embodiments higher than about seventy-five percent (75%) or greater. As used herein, “denier” is a unit of measurement, i.e., linear mass density (g/9000 m), that defines the thickness of individual threads or filaments used in the creation of a fabric and refers to the fineness of a fiber. Fabrics with a high denier number are thick, sturdy, and inflexible, while fabrics with a low denier number are thin, flexible, soft, and silky. Using a high denier count yarn would be expected to detrimentally affect the openness factor of the fabric. The use of yarn having a denier of about 25 and higher, including a denier as low as about 25 to as high as about 35, e.g., a 30 denier yarn, surprisingly and unexpectedly reduces and/or prevents the formation of undesirable wrinkles or puckers or creases, while preserving the desired visibility through the sheer (openness factor) in a light-controlling panel. The example 30 denier yarn has considerably less elongation (stretch) and retains its dimensions and shape with little to no effect on its view-through (openness factor), and the consistency of the elongation of the fabric under load from sample to sample, i.e., the standard deviation of the amount of elongation under load, is considerably improved. It will be understood to those skilled in the art that while a 25-35 denier yarn Tulle fabric is selected in one or more embodiments to achieve an openness factor of as low as about sixty percent (60%) and as high as about eighty five percent (85%) while preventing elongation and formation of puckers, other ranges of the denier for different openness factors are within the scope of this disclosure.

Various physical properties of a 30 denier polyester yarn Tulle fabric were tested and compared to those of the 20 denier polyester yarn Tulle fabric knitted using the same process and subjected to the same finishing process (described below). It was unexpectedly found that while the 30 denier yarn Tulle fabric has an openness factor that is only about 2% to about 3% less open, and more specifically in an example about 2.7% less open than that of the 20 denier yarn Tulle fabric, unexpectedly various other properties of the 30 denier yarn Tulle fabric that reduce or prevent formation of creases or wrinkles or puckers and/or elongation (or other deformation) over time were markedly different from those of the 20 denier yarn Tulle fabric. Denier yarn values of as low as about 25 denier to as high as about 35 denier, and in a specific embodiment about 30 denier yarn, for the diamond grid sheer fabric, e.g., a Tulle fabric, used in the rear panel of the covering 100 in combination with a Leno sheer fabric as the front panel is unique and achieves unexpected results of a dimensionally stable fabric with remarkably less stretch or elongation, which reduces or eliminates the formation of unsightly wrinkles or creases or puckers, while not sacrificing view through (the openness factor) when compared to a comparable 20 denier yarn knit Tulle fabric.

For example, when pulled in the MD on a calibrated INSTRON™ tensile tester using a 0.03 pound force, the 30 denier yarn Tulle fabric on average undergoes about 35% to about 37%, and more specifically about 36%, less elongation compared to the 20 denier yarn Tulle fabric. Importantly, the elongation of the example 30 denier yarn Tulle fabric was found to be markedly more stable and consistent in elongation testing with about 73% less variability compared to the 20 denier yarn Tulle fabric over time or upon repeated application of the 0.03 pound force. The example 30 denier yarn Tulle fabric when pulled in the MD on a calibrated INSTRON™ tensile tester using a 2 pound force also undergoes on average about 40% to about 44%, and more specifically about 42%, less elongation compared to the 20 denier yarn Tulle fabric. The elongation of the example 30 denier yarn Tulle fabric was found on average to be about 36% to 38% less variable, more specifically about 37% less variable, in MD compared to the 20 denier yarn Tulle fabric over time or upon repeated application of the 2 pound force. The 30 denier yarn Tulle fabric has lower elongation and a much more consistent amount of elongation which is advantageous for manufacturability as it retains its dimensions and shape much better and does not elongate as much upon application of a load. The difference in standard deviation of the percent elongation of the example 30 denier Tulle fabric versus the 20 denier Tulle fabric permits better tolerances during manufacturing of the panel. This results in an unexpectedly better and improved light-controlling panel, which has less unsightly wrinkles or “puckers”.

Moreover, the example 30 denier yarn Tulle fabric is stronger than the 20 denier yarn Tulle fabric. Thinner, low denier yarns (e.g., 20 denier yarn) can have less strength and abrasion resistance and thus be susceptible to breakage due to the stresses and strains during weaving, knitting, or other construction, as well as during normal usage. Therefore, use of higher denier yarn (e.g., 25-35 denier yarn) can help protect the yarn from such stresses and strains during manufacture and usage. This is apparent from increased resistance to tearing and increased maximum break load of the example 30 denier yarn fabric. The maximum break load and elongation of the example 30 denier yarn Tulle fabric upon application of a continually increasing tension, a measure of the strength of fabric, was found in the MD to be on average about 72% to about 74%, more specifically about 73%, more than that of the 20 denier yarn Tulle fabric. Additionally, the example 30 denier yarn Tulle fabric is also more resistant to tearing in the MD compared to the 20 denier yarn Tulle fabric. For example, the example 30 denier yarn Tulle fabric on average is about 42% to about 44%, and more specifically on average about 43%, more resistant to tearing in the MD.

The above percentage differences between the elongation properties of the 30 denier yarn and the 20 denier yarn Tulle fabric are exemplary and other values are within the scope of this disclosure. A preferred fabric has a desired openness factor and also is resistant to elongation, puckers, and tearing during manufacturing as well as usage.

FIGS. 10 and 11 illustrate the representative knit structure of a 20 denier monofilament yarn Tulle fabric (1001) and a 30 denier monofilament yarn Tulle fabric (1101), respectively on a MOTIC DIGITAL™ Microscope Model # DM143 with the arrow “MD” indicating the machine direction. Both samples were prepared using a 28 gauge knitter and then both samples were stretched to about 20 gauge. A MOTIC DIGITAL™ Microscope Model # DM143 was used to determine the percent openness of the 20 denier yarn and the 30 denier yarn Tulle fabric. The percentage openness of the 20 denier yarn Tulle fabric was determined to be about 83.62%, and the percentage openness of the 30 denier yarn Tulle fabric was determined to be about 81.32%. The difference in openness factor between the two Tulle knit sheer fabrics is only about 2% to 3% and is not readily apparent to the naked eye. In an embodiment, the 30 denier yarn Tulle fabric tested in this disclosure has an openness factor above 80%.

In an embodiment, the 30 denier yarn Tulle fabric when pulled on a calibrated INSTRON™ tensile tester using a 0.03 pound force in the MD direction has an elongation percentage on average of about 0.45%, with a minimum elongation of about 0.37% and a maximum elongation of about 0.49%. The standard deviation of elongation percentage testing on the example 30 denier yarn Tulle sheer fabric in the MD direction using a 0.03 pound force was 0.051 lbs. The 30 denier yarn Tulle fabric when pulled on a calibrated INSTRON™ tensile tester using a 2 pound force has an elongation percentage in the MD direction on average of about 3%, with a minimum elongation of about 2.8% and a maximum elongation of about 3.5%. The standard deviation of elongation percentage testing on the 30 denier yarn Tulle sheer fabric using a 2 pound force in the MD direction was 0.297 lbs. The 30 denier yarn Tulle fabric has a maximum break load, in the MD direction, on average of about 13.58 lbf, with a minimum break load of about 11.72 lbf and a maximum break load of about 14.98 lbf, with an accompanying average elongation of about 0.78 inches, and a minimum elongation of about 0.664 inches and a maximum elongation of about 0.876 inches. The percent of elongation of the 30 denier Tulle fabric in the MD direction at the maximum break load in the MD direction is on average not more than fifteen percent (15%). The 30 denier yarn Tulle fabric tears under a trapezoid tearing load on average in the MD of about 6.583 lbf, with a minimum tearing load of about 5.823 lbf and a maximum tearing load of about 7.436 lbf. It is believed that the denier of the yarn forming the sheer fabric imparts, at least in part, the improved elongation properties in the machine direction (MD) upon application of a force in the machine direction, as well as the improved variability (e.g., standard deviation) of the elongation in the machine direction (MD) upon application of a force in the machine direction (MD). It is also believed that the denier of the yarn forming the sheer fabric imparts, at least in part, the improved maximum break load and trapezoid tearing load in the machine direction (MD).

In an embodiment, the example 30 denier yarn Tulle fabric, when pulled in the CD direction on a calibrated INSTRON™ tensile tester using a 0.03 pound force, has an average elongation percentage of about 4.5%, with a minimum elongation percentage of about 4.0% and a maximum elongation percentage of about 5.2%. The standard deviation of elongation percentage testing in the CD direction using a 0.03 pound force was 0.455 lbs. The 30 denier yarn Tulle fabric when pulled in the CD direction on a calibrated INSTRON™ tensile tester using a 2 pound force has on average an elongation percentage of about 90%, with a minimum elongation of about 85% and a maximum elongation of about 95%. The standard deviation of elongation percentage testing in the CD direction using a 2 pound force was 3.555 lbs. The 30 denier yarn Tulle fabric has a maximum break load, in the CD direction, of, on average, 5.1 lbf, with a minimum break load of 4.34 lbf and a maximum break load of about 6.02 lbf, (with an accompanying elongation on average of about 3.8 inches, with a minimum elongation of about 3.5 inches and a maximum elongation of about 4.0 inches). The percent of elongation of the 30 denier Tulle fabric in the CD direction at the maximum break load in the CD direction is on average is considerably higher than the percentage of elongation in the MD direction and is on average between about 60% and 65%. The 30 denier yarn Tulle fabric tears under a trapezoid tearing load in the CD direction on average of about 6.1 lbf, with a minimum tearing load of about 5.4 lbf and a maximum tearing load of about 7.1 lbf.

In an embodiment, the Tulle sheer fabric has an elongation percentage on average less than about 0.70% in the machine direction (MD) upon application of a 0.03 pound force and the variability of elongation of the Tulle sheer fabric in the MD is on average less than about 0.100%. The Tulle sheer fabric in an aspect has an elongation percentage on average less than about 5.0%, preferably less than about 3.0%, in the MD upon application of a 2 pound force and the variability of elongation of the Tulle sheer fabric in the machine direction is on average less than 0.38%. The Tulle sheer fabric has a maximum break load of greater than about 10 pound force in the MD (with an elongation of on average as low as about 0.65 inches to as high as about 0.85 inches upon application of maximum break load), and in a further aspect has a trapezoid tearing load of on average less than about 5.50 pound force in the machine direction (MD).

### Testing of Fabric Tulle Samples

Various testing of the 30 denier yarn Tulle fabric are described and reported below. Each test was performed on 5 samples of fabric in the MD and the CD. Each of the Tulle fabric samples were knitted with 30 denier monofilament, polyester yarns on a 28 gauge machine and then the fabric was stretched to approximately 20 gauge.

Elongation and Deformation

This test is performed to determine the elongation of material when stretched and held at specific weight. Sample fabric pieces of a pre-determined size are loaded in an INSTRON™ Model 4444 Tensile Tester and a steady load is applied to the sample fabrics. A load cell and 0.75″ serrated wedge grips were used for conducting the test. The elongation testing in the MD would simulate a load applied to the Tulle fabric in a light-controlling panel.

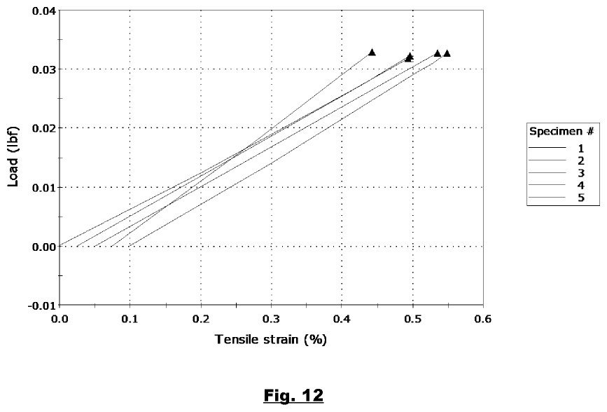

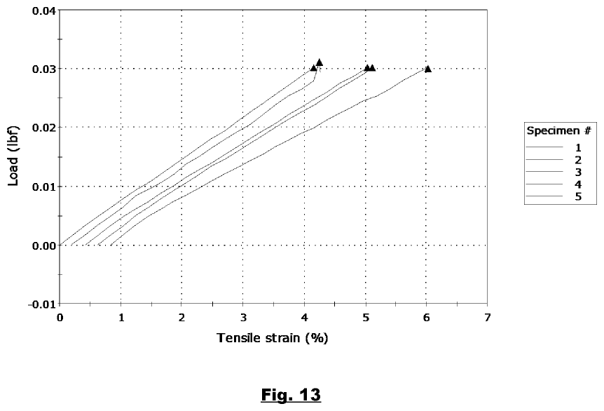

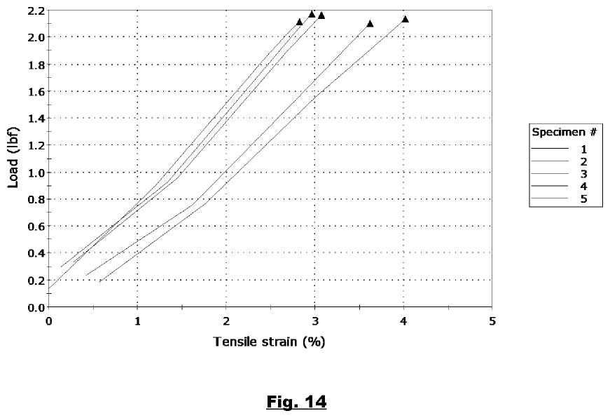

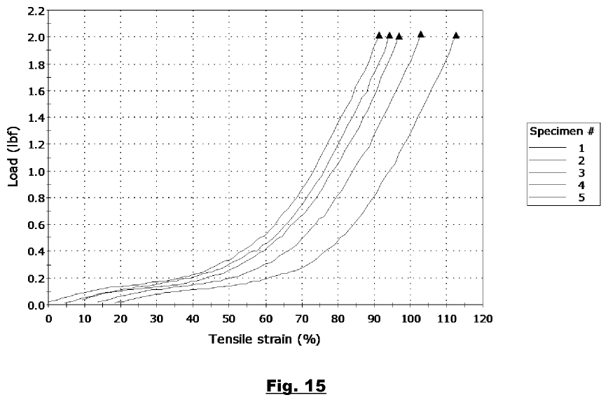

The elongation was first tested using a 0.03 pound force (lbf). The test was run at a constant crosshead speed of 1.5 in./min with a grip distance of 3.0″. The size of the fabric samples were 1.0″×6.0″. Results of the elongation and deformation test are shown for 30 denier yarn fabric in TABLE 1(a) and FIG. 12 for the MD, and Table 1(b) and FIG. 13 for the CD.

TABLE 1(a)

| | | | Tensile | Tensile |
|---|---|---|---|---|
| | | | extension | strain at |
| | | Maximum | at | Maximum |
| | Elongation | Load | Maximum | Load |
| | (%) | (lbf) | Load (in) | (in/in) |
| Sample 1 | 0.493 | 0.032 | 0.030 | 0.005 |
| Sample 2 | 0.472 | 0.032 | 0.028 | 0.005 |
| Sample 3 | 0.486 | 0.033 | 0.029 | 0.005 |
| Sample 4 | 0.368 | 0.033 | 0.022 | 0.004 |
| Sample 5 | 0.451 | 0.033 | 0.027 | 0.005 |
| Mean | 0.454 | 0.032 | 0.027 | 0.005 |
| Std. Dev. | 0.051 | 0.000 | 0.003 | 0.001 |
| Minimum | 0.368 | 0.032 | 0.022 | 0.004 |
| Maximum | 0.493 | 0.033 | 0.030 | 0.005 |

TABLE 1(b)

| | | | Tensile | Tensile |
|---|---|---|---|---|
| | | | extension | strain at |
| | | Maximum | at | Maximum |
| | Elongation | Load | Maximum | Load |
| | (%) | (lbf) | Load (in) | (in/in) |
| Sample 1 | 4.159 | 0.030 | 0.250 | 0.042 |
| Sample 2 | 4.034 | 0.031 | 0.242 | 0.040 |
| Sample 3 | 4.618 | 0.030 | 0.277 | 0.046 |
| Sample 4 | 4.494 | 0.030 | 0.270 | 0.045 |
| Sample 5 | 5.192 | 0.030 | 0.312 | 0.052 |
| Mean | 4.500 | 0.030 | 0.270 | 0.045 |
| Std. Dev. | 0.455 | 0.000 | 0.027 | 0.005 |
| Minimum | 4.034 | 0.030 | 0.242 | 0.040 |
| Maximum | 5.192 | 0.031 | 0.312 | 0.052 |

The elongation of the 30 denier Tulle fabric samples was also tested using a 2 lb load. The test was run at a constant crosshead speed of 12.0 in./min with a grip distance of 1.0″. The size of the fabric samples were 1.0″×2.5″. Results of the elongation and deformation test are shown for a 30 denier yarn fabric in TABLE 2(a) and FIG. 14 for the MD, and Table 2(b) and FIG. 15 for the CD.

TABLE 2(a)

| | | | Tensile | Tensile |
|---|---|---|---|---|
| | | | extension | strain at |
| | | Maximum | at | Maximum |
| | Elongation | Load | Maximum | Load |
| | (%) | (lbf) | Load (in) | (in/in) |
| Sample 1 | 2.824 | 2.118 | 0.028 | 0.028 |
| Sample 2 | 2.824 | 2.169 | 0.028 | 0.028 |
| Sample 3 | 2.789 | 2.164 | 0.028 | 0.028 |
| Sample 4 | 3.204 | 2.099 | 0.032 | 0.032 |
| Sample 5 | 3.454 | 2.137 | 0.035 | 0.035 |
| Mean | 3.019 | 2.137 | 0.030 | 0.030 |
| Std. Dev. | 0.297 | 0.030 | 0.003 | 0.003 |
| Minimum | 2.789 | 2.099 | 0.028 | 0.028 |
| Maximum | 3.454 | 2.169 | 0.035 | 0.035 |

TABLE 2(b)

| | | | Tensile | Tensile |
|---|---|---|---|---|
| | | | extension | strain at |
| | | Maximum | at | Maximum |
| | Elongation | Load | Maximum | Load |
| | (%) | (lbf) | Load (in) | (in/in) |
| Sample 1 | 91.417 | 2.013 | 0.914 | 0.914 |
| Sample 2 | 92.208 | 2.011 | 0.922 | 0.922 |
| Sample 3 | 85.074 | 2.013 | 0.851 | 0.851 |
| Sample 4 | 89.203 | 2.021 | 0.892 | 0.892 |
| Sample 5 | 94.459 | 2.013 | 0.945 | 0.945 |
| Mean | 90.472 | 2.014 | 0.905 | 0.905 |
| Std. Dev. | 3.555 | 0.004 | 0.036 | 0.036 |
| Minimum | 85.074 | 2.011 | 0.851 | 0.851 |
| Maximum | 94.459 | 2.021 | 0.945 | 0.945 |

Cut-Strip Tensile Test

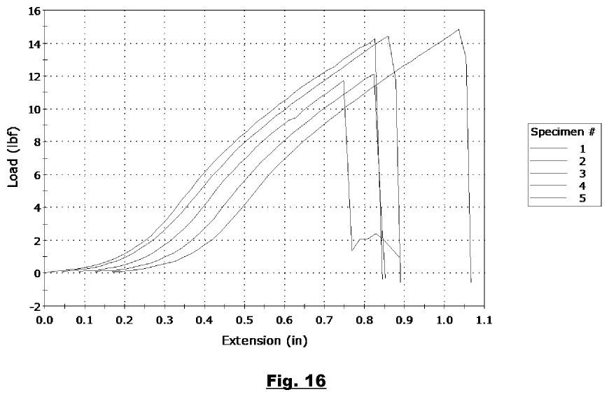

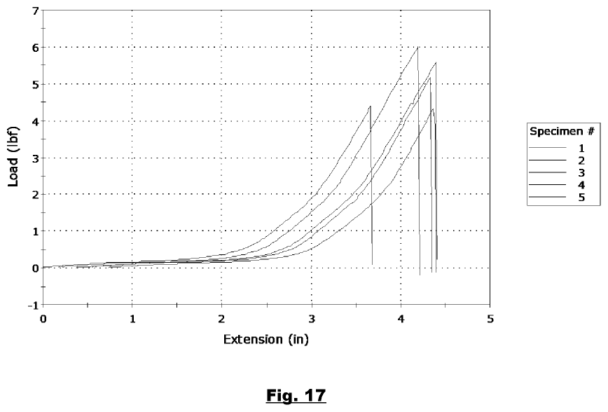

A cut strip tensile test was conducted to determine the maximum break load and elongation when a continually increasing tension is applied to the sample fabric at a constant rate of speed in an INSTROM™ Model 4444 tensile tester. This test is used to measure the strength of the fabric. The size of the fabric samples were 1.0″×6.0″, and the test was run at a constant crosshead speed of 12.0 in./min with a grip distance of 3.0″. The grippers of the INSTROM™ tester for the tensile tests grip the fabric sample along the 1.0″ width for both the MD direction and the CD direction tests. Results of the tensile test are shown for 30 denier yarn fabric in TABLE 3(a) and FIG. 16 for the MD, and Table 3(b) and FIG. 17 for the CD.

TABLE 3(a)

| | | Displacement | |
|---|---|---|---|
| | Load at Max. | at Max. | |
| | Load (lbf) | Load (in) | % Displacement |
| Sample 1 | 14.280 | 0.826 | 13.76 |
| Sample 2 | 14.600 | 0.827 | 13.78 |
| Sample 3 | 11.720 | 0.664 | 11.07 |
| Sample 4 | 12.320 | 0.706 | 11.77 |
| Sample 5 | 14.980 | 0.876 | 14.60 |
| Mean | 13.580 | 0.780 | 13.00 |
| Std. Dev. | 1.461 | 0.090 | |
| Minimum | 11.720 | 0.664 | 11.07 |
| Maximum | 14.980 | 0.876 | 14.60 |

TABLE 3(b)

| | | Displacement | |
|---|---|---|---|
| | Load at Max. | at Max. | |
| | Load (lbf) | Load (in) | % Displacement |
| Sample 1 | 4.435 | 3.676 | 61.27 |
| Sample 2 | 6.019 | 4.014 | 66.90 |
| Sample 3 | 5.573 | 4.027 | 67.12 |
| Sample 4 | 5.162 | 3.777 | 62.95 |
| Sample 5 | 4.341 | 3.637 | 60.62 |
| Mean | 5.106 | 3.826 | 63.77 |
| Std. Dev. | 0.723 | 0.185 | |
| Minimum | 4.341 | 3.637 | 60.62 |
| Maximum | 6.019 | 4.027 | 67.12 |

Trapezoid Tear

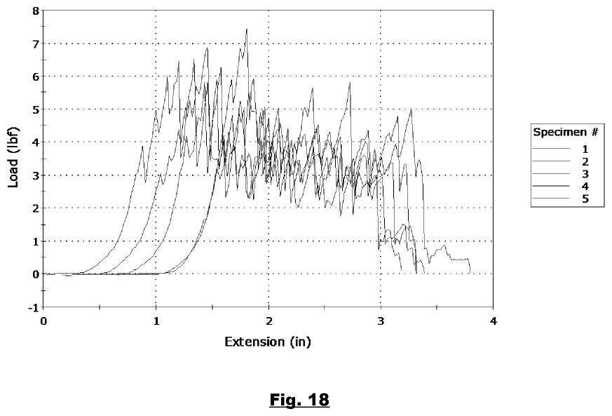

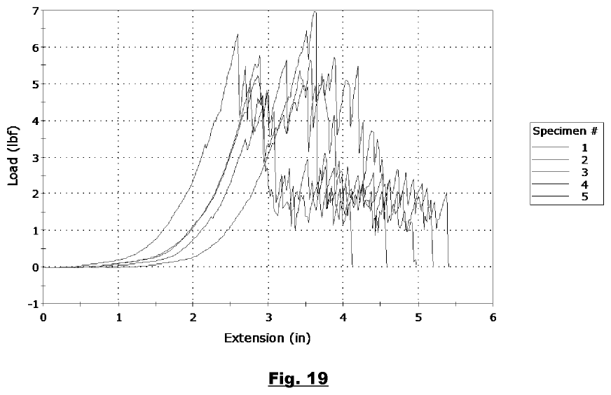

The trapezoid tear test was conducted to determine the average tearing load of the fabric samples with a continually increasing load. This test was a measure of the tearing strength of a material or materials when a constantly increasing load was applied parallel to the length of the specimen. In nonwoven fabrics where the individual fibers are more or less randomly oriented and capable of some reorientation in the direction of the applied load, the maximum trapezoid tearing strength is reached when the resistance to further reorientation is greater than the force required to rupture one or more fibers simultaneously. The measured tearing strength of the specimen provides information on the fabrics ability to resist a continuous tear and/or formation of pills. An INSTROM™ Model 4444 tensile tester was used and the test was run at a constant crosshead speed of 12.0 in./min with a grip distance of 1.0″. The size of the samples were 3.0″×6.0″. Results of the tear test are shown for 30 denier yarn fabric in TABLE 4(a) and FIG. 18 for the MD, and Table 4(b) and FIG. 19 for the CD.

TABLE 4(a)

| | Load at | Displacement at |
|---|---|---|
| | Max. Load (lbf) | Max. Load (in) |
| Sample 1 | 6.518 | 1.345 |
| Sample 2 | 6.862 | 1.296 |
| Sample 3 | 6.276 | 1.246 |
| Sample 4 | 7.436 | 1.314 |
| Sample 5 | 5.823 | 2.067 |
| Mean | 6.583 | 1.454 |
| Std. Dev. | 0.609 | 0.345 |
| Minimum | 5.823 | 1.246 |
| Maximum | 7.436 | 2.067 |

TABLE 4(b)

| | Load at | Displacement at |
|---|---|---|
| | Max. Load (lbf) | Max. Load (in) |
| Sample 1 | 6.360 | 2.604 |
| Sample 2 | 5.777 | 3.687 |
| Sample 3 | 5.764 | 2.476 |
| Sample 4 | 5.436 | 3.116 |
| Sample 5 | 7.068 | 2.804 |
| Mean | 6.081 | 2.937 |
| Std. Dev. | 0.644 | 0.484 |
| Minimum | 5.436 | 2.476 |
| Maximum | 7.068 | 3.687 |

The example 30 denier yarn Tulle fabric was unexpectedly better at maintaining its shape and structure compared to the 20 denier yarn fabric while maintaining substantially the same openness factor, and providing surprisingly much better variability in characteristics that affect fabric stretching and wrinkle formation.

The Tulle may be formed of yarn having a denier of about 25 denier to about 35 denier, preferably a 30 denier yarn, that may be monofilament or multifilament. The Tulle fabric may be made, for example, with either a 30/1 or a 30/12 yarn, where the 30/12 is a 30 denier yarn with 12 filaments while the 30/1 is a 30 denier yarn with a single or monofilament. The 30/1 monofilament yarn has a slightly smaller overall diameter and thus, when formed into a sheer, has better view through and openness factor than the 30/12 and may be the preferred choice. The yarn, preferably a 30 denier yarn, is made from polyester.

Tulle sheer fabrics, made from 30 denier yarns in very open grid constructions, for example with a 25-30 gauge warp knitter, a 50-60 gauge knitter with every other needle removed to create a 25-30 gauge Tulle fabric, or where a Tulle fabric is made on a larger-gauge knitter and the fabric is finished by stretching to an about 20-gauge fabric, can provide good view-through while avoiding or reducing moiré or interference patterns with the Leno weave face sheer. The Tulle sheer fabric may be made on a 28-gauge warp knitting machine where 28 warp yarns per inch are fed into the knitter, and no fill yarns are used on the warp knitter. The fabric in an embodiment is pulled out in the finishing process such that there are less than 28 gauge (yarns) per inch in the cross (width) direction (e.g., 20 gauge yarns per inch). In an exemplary embodiment, the diamond grid sheer fabric formed from a plurality of yarns having a denier of about 25 to a denier of about 35 used for the rear support member is about 20 gauge (yarns) in the cross (width) direction and about 10 courses in the machine (courses per inch). In an alternative embodiment, the Tulle fabric with about 30 denier yarn may be knitted on a 20-gauge knitter without pulling during the finishing process to create a 20-gauge Tulle diagonal structured fabric, a 32-gauge knitter with every other needle removed to create a 16-gauge Tulle diagonal structured fabric, or the like. In an embodiment, a diamond grid sheer fabric made from about 30 denier yarn for the rear support member is prepared on a 28-gauge knitter and is finished by stretching to about a 20-gauge fabric where the openness factor is about 80% or greater and the openings have dimensions of about 10.7 mm in width and about 14.1 mm in length.

The present disclosure features in one or more embodiments an improved sheer fabric for use in a fabric panel, the sheer fabric including: a plurality of yarns having a denier of about 25 and greater, including a denier from about 25 up to 35, wherein the plurality of yarns are configured to form a plurality of diamond or diagonal structures each forming a diamond-shaped opening, wherein the sheer fabric has an openness factor of about seventy five percent (75%) and greater. In one or more embodiments the sheer fabric for use in the fabric panel is arranged so that the load is angularly oriented with respect to the yarns, e.g., the load is not aligned with the yarns forming the sheer fabric. It will be understood to those skilled in the art that the openness factor percentages are within a normal range of measurement error ranges. In an embodiment, the sheer fabric is a Tulle sheer fabric. The sheer fabric in one or more embodiments has an elongation percentage upon application of a 0.03 pound force in the machine direction (MD) of on average less than about 0.70% in the machine direction (MD) with a variability of the elongation percentage of, in an aspect, on average less than 0.100% upon application of the 0.03 pound force in the machine direction (MD). The sheer fabric, additionally or alternatively, in an aspect, has an elongation percentage upon application of a 2 pound force in the machine direction (MD) of on average less than about 5.0%, preferably about 3.0% or less, in the machine direction (MD) with a variability of the elongation percentage of, according to an embodiment, on average less than 0.38% upon application of the 2 pound force in the machine direction (MD). Optionally, the sheer fabric in an embodiment has a maximum break load of on average greater than 10 pound force in the machine direction (MD). The sheer fabric alternatively or additionally, in an embodiment, has a trapezoid tearing load of on average greater than 5.5 pound force in the machine direction (MD).

The plurality of yarns forming the diagonal structure in a further aspect comprises polyester and the diamond-shaped openings in one or more embodiments have dimensions of about 10.7 mm in width and about 14.1 mm in length. The fabric panel in a particular embodiment is configured to have an outer front vertical support member having a height and a width; an outer rear vertical support member having a height and a width, the rear vertical support member substantially parallel to the front vertical support member when the panel is under the influence of gravity, and the rear vertical support member being laterally moveable relative to the front vertical support member; and a plurality of vanes extending from the front vertical support member to the rear vertical support member, wherein the front vertical support member and the rear vertical support members are torsionally attached to at least one of the plurality of slats.

The present disclosure also features in one or more embodiments an improved fabric panel and/or covering for architectural features, which may include windows, doorways, archways and the like, that prevents the formation of wrinkles, puckers, creases, etc. In an embodiment, the covering includes a flexible panel. The flexible panel in an embodiment including a front vertical support member having a height and width; a rear vertical support member having a height and a width, the rear vertical support member substantially parallel to the front vertical support member and laterally moveable relative to the front vertical support member; and a plurality of vanes extending from the front vertical support member to the rear vertical support member, wherein: both the front and rear vertical support members control the movement and angular orientation of the vanes, and at least one of the front or rear vertical support members is a sheer fabric knitted from a plurality of yarns arranged to form a plurality of diamond diagonal structures each having a diamond-shaped opening wherein each of the plurality of yarns have a denier of about 25 and greater. The sheer fabric in an embodiment is a Tulle sheer fabric. In a further aspect, the plurality of yarns have a denier of about 25 up to about 35, and in a particular aspect have a denier of about 30. The knitted sheer fabric according to an embodiment has an openness factor that is about sixty-five percent (65%) and greater, and in particular embodiments has an openness factor that is about eighty percent (80%) and greater. It will be understood to those skilled in the art that the openness factor percentages are within a normal range of measurement error ranges. The knitted sheer fabric in a further embodiment forms the rear vertical support member, the front vertical support member is a woven sheer fabric, and the openness factor of the rear vertical support member is greater than the openness factor of the front vertical support member.

The knitted sheer fabric in one or more embodiments has an elongation percentage of on average less than about 0.70% in the machine direction (MD) upon application of a 0.03 pound force in the machine direction (MD). A variability of the elongation percentage of the knitted sheer fabric upon application of the 0.03 pound force in the machine direction (MD) according to an embodiment is on average less than about 0.100% in the machine direction (MD). Additionally or alternatively, the knitted sheer fabric in one or more embodiments has an elongation percentage of on average less than about 5.0%, preferably about 3% or less, in the machine direction (MD) upon application of a 2 pound force. A variability of the elongation percentage of the knitted sheer fabric upon application of the 2.0 pound force in the machine direction (MD) according to an embodiment is on average less than 0.38% in the machine direction. In a further embodiment, the knitted sheer fabric has a maximum break load of greater than about 10 pound force in the machine direction (MD). The knitted sheer fabric according to another embodiment additionally or alternatively has a trapezoid tearing load of on average greater than about 5.50 pound force in the machine direction (MD). The elongation percentage upon application of a force in the machine direction (MD), the maximum break load in the machine direction (MD), and the trapezoid tearing load in the machine direction (MD) is, in one or more embodiments, wholly, or at least in part, attributable or the result from the plurality of yarns forming the sheer fabric having a denier of about 25 up to about 35, and in an embodiment, a denier of about 30.

In one embodiment, a rear twenty-eight (28) gauge diamond grid knit sheer fabric, e.g., a Tulle sheer fabric, made from a dark (for example, grey or black) 30 denier yarn, preferably polyester yarn, is used, in combination with a Steiger Leno front sheer made from 20 denier yarns having 15-30 ypi in the cross direction and 15-30 ypi in the machine (weft) direction. In one embodiment, a Steiger Leno front sheer having rectangularly-shaped openings of about 7.3 mm in width and 4.1 mm in length is paired with a Tulle rear sheer made from 30 denier monofilament yarns prepared on a 28-gauge knitter that is finished by stretching to about a 20 gauge fabric where the openings are about 10.7 mm in width and about 14.1 mm in length. The Leno fabric and Tulle sheer fabrics may both be dark (for example, gray or black) and/or one of the fabrics may be lighter (for example, gray vs. black), or a light color (for example, beige or white). Optionally, the rear support member fabric may be the Leno weave fabric and the front support member may be the knit Tulle fabric. The sheer fabrics, in particular a Leno weave and a Tulle knit, may be used with non-cellular vanes, multi-layered cellular vanes, and combinations thereof.

In an embodiment the front support member may have an openness factor of about as low as sixty-five percent (65%) or greater, and further may be a Steiger Leno made of 15 to 25 denier warp yarn, preferably a 20 denier yarn, and about 45-55 denier weft yarn, and may have about 15-30 ypi in the cross (warp) and machine (weft) direction. A covering in one embodiment has a Tulle sheer made from about 25 denier to about 35 denier yarn, preferably 30 denier yarn, having an openness factor of about eighty percent (80%) or greater for one of the front or rear vertical support members and a Leno sheer fabric having an openness factor of about sixty-five percent (65%) or greater for the other of the front or rear vertical support members where in an aspect at least the rear support member is optionally darker than the front support member, and may a dark or black color. For example, the dark vertical support members may be solution dyed, dispersion dyed, or both solution and dispersion dyed with carbon black. In one aspect, one or more support members may be dark and made from carbon black pigment colored material, preferably polyester. In one embodiment, the front vertical support member may be white, off-white, and clear and/or colored with titanium pigment, or vice versa. Having vertical support members with high openness factors and dark colors may increase view-through, and enhanced visibility of the vane elements may be achieved in certain embodiments.

In one embodiment a panel may be formed of a front vertical support member and a rear vertical support member each having an openness factor greater than sixty (60%) and the panel may further have non-cellular vanes, multilayered cellular vanes, or a mixture of both vane types. In one embodiment the rear support member may be a black sheer with an openness factor of about seventy-five percent (75%) or greater, and further may be an about 16 to about 28-gauge Tulle knit fabric, for example a 28-gauge Tulle that is finished by stretching to a 20-gauge sheer. The Tulle may be formed of an about 25 denier to 35 denier yarn, preferably a 30 denier yarn, that may be monofilament or multifilament. In one embodiment the front support member may have an openness factor of about sixty-five percent (65%) or greater, and further may be a Steiger Leno and may have about 15-30 ypi in the cross (warp) and 45-55 ypi in the machine (weft) direction. The Tulle and Steiger Leno sheers with openness factors greater than sixty-five percent (65%) may be used with single layer non-cellular vanes configured in the privacy or shading orientation. In one embodiment, a covering having all non-cellular vanes, all multilayered cellular vanes, or a combination of non-cellular and cellular vanes may have a 30 denier yarn Tulle sheer having an openness factor of about eighty percent (80%) or greater for one of the front or rear vertical support members and a Leno fabric having an openness factor of about sixty-five percent (65%) or greater for the other of the front or rear vertical support members where at least the rear support member may be a dark or black color.

Those skilled in the art will recognize that the sheer fabric, fabric panel and/or architectural covering has many applications, may be implemented in various manners and, as such is not to be limited by the foregoing embodiments and examples. Any number of the features of the different embodiments described herein may be combined into a single embodiment. Alternate embodiments are possible that have features in addition to those described herein or may have less than all the features described. Functionality may also be, in whole or in part, distributed among multiple components, in manners now known or to become known.

For the foregoing reasons, it is clear that the disclosure provides an innovative fabric design that has the potential to improve the aesthetics of currently available window coverings by reducing elongation and unsightly wrinkle formation. The fabric disclosed herein may be modified in multiple ways and applied in various technological applications. For example, although much of the discussion is directed toward the use of 30 denier yarn fabric in the covering 100 of FIGS. 1-9 as the rear panel, this fabric may also be used as the front support member of the fabric panel, for example, and denier other than about 30 denier can be used for the yarn, and yarns configured in structures other than a diamond or diagonal grid are contemplated.

It will be appreciated by those skilled in the art that changes could be made to the embodiments described above without departing from the broad inventive concept. It is understood, therefore, that this invention is not limited to the particular embodiments disclosed, but it is intended to cover modifications within the spirit and scope of the invention. While fundamental features of the invention have been shown and described in exemplary embodiments, it will be understood that omissions, substitutions, and changes in the form and details of the disclosed embodiments of the sheer fabric, fabric panel, and/or architectural covering may be made by those skilled in the art without departing from the spirit of the invention. Moreover, the scope of the invention covers conventionally known, and future-developed variations and modifications to the components described herein as would be understood by those skilled in the art.

In the claims, the term “comprises/comprising” does not exclude the presence of other elements, features, or steps. Furthermore, although individually listed, a plurality of means, elements, or method steps may be implemented by, e.g., a single unit, element, or piece. Additionally, although individual features may be included in different claims, these may advantageously be combined, and their inclusion individually in different claims does not imply that a combination of features is not feasible and/or advantageous. In addition, singular references do not exclude a plurality. The terms “a”, “an”, “first”, “second”, etc., do not preclude a plurality. Reference signs or characters in the disclosure and/or claims are provided merely as a clarifying example and shall not be construed as limiting the scope of the claims in any way.

The foregoing description has broad application. It should be appreciated that the concepts disclosed herein may apply to many types of fabric panels, coverings or shades, in addition to those described and depicted herein. Similarly, it should be appreciated that the concepts disclosed herein may apply to many types of coverings, in addition to the coverings described and depicted herein. For example, the concepts may apply equally to a top rail or any other rail movable through a handle assembly. The discussion of any embodiment is meant only to be explanatory and is not intended to suggest that the scope of the disclosure, including the claims, is limited to these embodiments. In other words, while illustrative embodiments of the disclosure have been described in detail herein, it is to be understood that the inventive concepts may be otherwise variously embodied and employed, and that the appended claims are intended to be construed to include such variations, except as limited by the prior art.

1. A sheer fabric for use in a fabric panel comprising:
a plurality of yarns having a denier from about 25 up to 35, wherein the plurality of yarns are configured to form a plurality of diagonal structures each having a diamond-shaped opening, wherein the sheer fabric has an openness factor of about seventy five percent (75%) and greater.

2. The sheer fabric according to claim 1, wherein the sheer fabric has an elongation percentage upon application of a 0.03 pound force in the machine direction (MD) of on average less than about 0.70% in the machine direction (MD) with a variability of the elongation percentage on average of less than 0.100% upon application of the 0.03 pound force in the machine direction (MD).

3. The sheer fabric according to claim 1, wherein the sheer fabric has an elongation percentage upon application of a 2 pound force in the machine direction (MD) of on average less than about 5.0% in the machine direction (MD) with a variability of the elongation percentage on average of less than 0.38% upon application of the 2 pound force in the machine direction (MD).

4. The sheer fabric according to claim 3, wherein the elongation percentage is imparted, at least in part, by the denier of the plurality of yarns.

5. The sheer fabric according to claim 1, wherein the sheer fabric has a maximum break load of on average greater than 10 pound force in the machine direction (MD).

6. The sheer fabric according to claim 1, wherein the sheer fabric has a trapezoid tearing load of on average greater than 5.5 pound force in the machine direction (MD).

7. The sheer fabric according to claim 1, where the plurality of yarns forming the diagonal structure comprises polyester and the diamond-shaped openings have dimensions of about 10.7 mm in width and about 14.1 mm in length.

8. The fabric panel of claim 1, further comprising:
an outer front vertical support member having a height and a width:
an outer rear vertical support member having a height and a width, the rear vertical support member substantially parallel to the front vertical support member when the panel is under the influence of gravity and laterally moveable relative to the vertical support member; and
a plurality of vanes extending from the front vertical support member to the rear vertical support member,
wherein the front vertical support member and the rear vertical support members are torsionally attached to at least one of the plurality of slats.

9. A flexible panel for an architectural feature, the flexible panel comprising:
a front vertical support member having a height and width;
a rear vertical support member having a height and a width, the rear vertical support member substantially parallel to the front vertical support member and laterally moveable relative to the front vertical support member; and
a plurality of vanes extending from the front vertical support member to the rear vertical support member:
wherein:
both the front and rear vertical support members control the movement and angular orientation of the vanes, and
at least one of the front or rear vertical support members is a sheer fabric knitted from a plurality of yarns to form a plurality of diagonal structures each having a diamond-shaped opening wherein each of the plurality of yarns have a denier of about 25 and greater.

10. The flexible panel according to claim 9, wherein the plurality of yarns have a denier of about 25 up to about 35.

11. The flexible panel according to claim 9, wherein the plurality of yarns have a denier of about 30.

12. The flexible panel according to claim 9, wherein the knitted sheer fabric has an openness factor that is about sixty-five percent (65%) and greater.

13. The flexible panel according to claim 9, wherein the knitted sheer fabric has an openness factor that is about eighty percent (80%) and greater.

14. The flexible panel according to claim 13, wherein the knitted sheer fabric forms the rear vertical support member, the front vertical support member is a woven sheer fabric, and the openness factor of the rear vertical support member is greater than the openness factor of the front vertical support member.

15. The flexible panel according to claim 13, wherein the knitted sheer fabric has an elongation percentage of on average less than about 0.70% in the machine direction (MD) upon application of a 0.03 pound force in the machine direction (MD).

16. The flexible panel according to claim 15, wherein a variability of the elongation percentage of the knitted sheer fabric upon application of the 0.03 pound force in the machine direction (MD) is on average less than about 0.100% in the machine direction (MD).

17. The flexible panel according to claim 13, wherein the knitted sheer fabric has an elongation percentage of on average less than about 5.0% in the machine direction (MD) upon application of a 2 pound force in the machine direction (MD).

18. The flexible panel according to claim 17, wherein a variability of the elongation percentage of the knitted sheer fabric upon application of the 2.0 pound force in the machine direction (MD) is on average less than 0.38% in the machine direction (MD).

19. The flexible panel according to claim 13, wherein the knitted sheer fabric has a maximum break load of greater than on average about 10 pound force in the machine direction (MD).

20. The flexible panel according to claim 13, wherein the knitted sheer fabric has a trapezoid tearing load of on average greater than about 5.50 pound force in the machine direction (MD).

21. The flexible panel according to claim 14, wherein the knitted sheer fabric is knitted from yarn comprising polyester and the diamond-shaped openings have dimensions of about 10.7 mm in width and about 14.1 mm in length.

22. The flexible panel of claim 13, wherein first end portions of the front and rear vertical support members are attached to a roller and second end portions of at least one the front or rear vertical support members are attached to an end rail.

23. The fabric panel of claim 13, wherein the front vertical support member and the rear vertical support members are torsionally attached to at least one of the plurality of slats.

24. A flexible panel for an architectural feature, the flexible panel comprising:
a front vertical support member having a height and width;
a rear vertical support member having a height and a width, the rear vertical support member substantially parallel to the front vertical support member and laterally moveable relative to the front vertical support member; and
a plurality of vanes extending from the front vertical support member to the rear vertical support member:
wherein:
both the front and rear vertical support members control the movement and angular orientation of the vanes, and
at least one of the front or rear vertical support members is a sheer fabric knitted from a plurality of yarns to form a plurality of diagonal structures each having a diamond-shaped opening wherein the knitted sheer fabric has:
an openness factor of about seventy five percent (75%) and greater, and
an elongation percentage upon application of a 2 pound force in the machine direction (MD) of on average less than about 5.0% in the machine direction (MD) with a variability of the elongation percentage on average of less than 0.38% upon application of the 2 pound force in the machine direction (MD).

25. The flexible panel according to claim 24, wherein the plurality of yarns have a denier of about 25 up to 35.

26. The flexible panel according to claim 24, wherein the knitted sheer fabric forms the rear vertical support member, the front vertical support member is a woven sheer fabric, and the openness factor of the rear vertical support member is greater than the openness factor of the front vertical support member.

27. The flexible panel according to claim 24, wherein the knitted sheer fabric has a maximum break load greater than on average about 10 pound force in the machine direction (MD).

28. The flexible panel according to claim 24, wherein the knitted sheer fabric has a trapezoid tearing load of on average greater than about 5.50 pound force in the machine direction (MD).

29. The flexible panel according to claim 24, wherein the plurality of yarns comprise polyester, and the diamond-shaped openings have dimensions of about 10.7 mm in width and about 14.1 mm in length
